(19) United States
(12) Patent Application Publication
(10) Pub. No.: US 2008/0195435 A1
(43) Pub. Date: Aug. 14, 2008

(54) Lifestyle-based vehicle selection system and method

(76) Inventors: Ian Bentley, Tampa, FL (US); William Ferriolo, Tampa, FL (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/975,311

(22) Filed: Oct. 18, 2007

Related U.S. Application Data
(60) Provisional application No. 60/901,431, filed on Feb. 14, 2007.

(51) Int. Cl. G06F 17/30

(52) U.S. Cl. 705/7

(57) ABSTRACT

Various embodiments of computer systems and methods are provided for enabling a consumer to search for vehicles based on lifestyle criteria. One embodiment comprises a computer system for enabling consumers to research vehicles. One such computer system comprises: a vehicle database configured to store a plurality of vehicle profiles, each vehicle profile associated with a unique vehicle and comprising a plurality of indicators related to vehicle characteristics and corresponding uniquely-assigned weights; and a lifestyle-based vehicle selection system for enabling a consumer to search the vehicle database by selecting at least one of a plurality of lifestyle categories, each lifestyle category associated with a portion of the plurality of indicators.

### CROSS-REFERENCE TO RELATED APPLICATION

This application claims the benefit of the priority of U.S. Provisional Patent Application Ser. No. 60/901,431, entitled “AUTOTROPOLIS LIFESTYLE INDEX” and filed Feb. 14, 2007, which is hereby incorporated by reference in its entirety.

### BACKGROUND

There are a number of computer systems and methods that enable consumers to research vehicles-of-interest. For example, many vehicle research web sites enable consumers to search a database that stores information about a number of vehicles. Typically, these web sites prompt a consumer to specify a make, model, or class of vehicle to search. The consumer selects a desired vehicle make, model or class to search, and perhaps a year and price range. Some sites also enable the user to search according to an industry classification or vehicle type (e.g., convertibles, minivans, vans, trucks, sports cars, 2-door, 4-door, sport utility vehicles, hybrids). Industry classifications or vehicle types define a group of vehicles based on a common mechanical or physical characteristic of vehicles.

The make/model/class on-line search methodology is the de facto industry standard. All known web sites which offer a vehicle research tool provide this functionality. In fact, the make/model/class search methodology is currently expected by most vehicle consumers, particularly those having an idea of the type of vehicle (if not exact make/model) they want to search. This type of specific, direct vehicle search based on mechanical or physical vehicle characteristics is only useful if the consumer has predetermined a particular vehicle-of-interest. After viewing the search results, the consumer may determine that this make/model/class is not as desirable as previously believed. In such cases, using the make/model/class search methodology, the consumer must return to the make/model/class step and specify another search. This process must be repeated until the consumer finally locates a vehicle which meets his/her specific wants or desires.

### SUMMARY

Various embodiments of computers systems and accompanying methods are provided for enabling a consumer to search for vehicles based on lifestyle criteria. One embodiment comprises a computer system for enabling consumers to research vehicles. One such computer system comprises: a vehicle database configured to store a plurality of vehicle profiles, each vehicle profile associated with a unique vehicle and comprising a plurality of indicators related to vehicle characteristics and corresponding uniquely-assigned weights; a lifestyle-based vehicle selection system for enabling a consumer to search the vehicle database, the lifestyle-based vehicle selection system comprising: a user interface; logic configured to prompt the consumer via the user interface to select at least one of a plurality of lifestyle categories, each lifestyle category associated with a portion of the plurality of indicators, the portion defining a set of primary indicators for a first search of the vehicle database; logic configured to determine the set of primary indicators assigned to the selected lifestyle category; and logic configured to initiate the first search of the vehicle database based on the set of primary indicators.

Another embodiment of such a computer system comprises: a vehicle database configured to store a plurality of vehicle profiles, each vehicle profile associated with a unique vehicle and comprising a plurality of indicators related to vehicle characteristics and corresponding uniquely-assigned weights; and a lifestyle-based vehicle selection system for enabling a consumer to search the vehicle database, the lifestyle-based vehicle selection system comprising: a user interface; a first search functionality for enabling the consumer to search the vehicle database based on a plurality of lifestyle categories, each lifestyle category associated with a portion of the plurality of indicators, the portion defining a set of primary indicators for a first search of the vehicle database, and the first search functionality comprising: logic configured to prompt the consumer via the user interface to select at least one of the plurality of lifestyle categories; logic configured to determine the set of primary indicators assigned to the selected lifestyle category; and logic configured to initiate the first search of the vehicle database based on the set of primary indicators; and a second search functionality for enabling the consumer to perform a second search of the vehicle database by directly selecting one or more of the plurality of indicators rather than the lifestyle categories.

Another embodiment comprises a computer-implemented method for enabling consumers to search for vehicles-of-interest via a web site. One such method comprises: providing a database comprising: a plurality of vehicle profiles, each vehicle profile associated with a unique vehicle and comprising (i) vehicle data related to the corresponding vehicle and (ii) a uniquely-assigned value for each of a plurality of purchase factors; and a plurality of lifestyle categories, each lifestyle category associated with a unique sub-set of the plurality of purchase factors; prompting a consumer to search the database of vehicles by selecting one of the plurality of lifestyle categories; receiving a consumer selection of one of the plurality of lifestyle categories; determining the unique sub-set of the plurality of purchase factors associated with the selected lifestyle category; and determining a top-ranked list of the plurality of vehicle profiles according to the uniquely-assigned values for the unique sub-set of the plurality of purchase factors.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a block diagram illustrating the architecture, implementation, and operation of one of a number of possible embodiments of a lifestyle-based vehicle selection system.

FIG. 2 is a data schema diagram illustrating an embodiment of a vehicle profile in the vehicle database of FIG. 1.

FIG. 3 is a data schema diagram illustrating an embodiment of the structure of various data elements related to the purchase factor values in the vehicle profile of FIG. 2.

FIG. 4 is a data structure diagram illustrating an embodiment of the logical mapping between a plurality of lifestyle categories and a sub-set of the purchase factors of FIG. 3.

FIG. 5 is a block diagram illustrating an embodiment of a computer system for implementing the lifestyle-based vehicle selection system of FIG. 1.

FIG. 6 is a flowchart illustrating the architecture, operation, and/or functionality of an embodiment of the lifestyle-based search functionality and the indicator-based search functionality of FIG. 5.

FIG. 7 is a user interface screen shot of an embodiment of a lifestyle-selection web page for enabling a consumer to interface with the lifestyle-based vehicle selection system of FIGS. 1 and 5.

FIG. 8 illustrates the lifestyle-selection web page of FIG. 7 in which the consumer is previewing a description of the “flash & style” lifestyle category.

FIG. 9 illustrates the lifestyle-selection web page of FIGS. 7 and 8 in which the consumer has selected the “flash & style” lifestyle category and specified a desired budget range.

FIG. 10a is a first portion of a user interface screen shot of an embodiment of a results web page for enabling the consumer to view the results of the search of the vehicle database and adjust the search criteria for a revised search.

FIG. 10b is a second portion of the user interface screen shot of FIG. 10a.

FIG. 11 illustrates the user interface screen shot of FIG. 10b in which the consumer has selected one of the vehicles in the search results.

FIG. 12 illustrates an embodiment of a search adjustment functionality in the user interface screen shot of FIG. 11 in which the consumer has adjusted the “style” and “drivability” indicators by selecting new target adjustment sub-ranges for a revised search of the vehicle database.

FIG. 13 illustrates another embodiment of a search adjustment functionality in which the consumer previews the current indicators for the revised search.

FIG. 14 illustrates the screen shot of FIG. 13 in which the consumer has selected two new indicators for the revised search.

FIG. 15a is a first portion of a user interface screen shot for a revised results web page.

FIG. 15b is a second portion of the user interface screen shot of FIG. 15a.

FIG. 16 illustrates the user interface screen shot of FIG. 15b in which the consumer has adjusted the “safety” and “reliability” indicators.

FIG. 17a is a first portion of a user interface screen shot for a vehicle selection web page for enabling the consumer to submit a pricing request for the vehicle.

FIG. 17b is a second portion of the user interface screen shot of FIG. 17a.

FIG. 18 is a user interface screen shot of an additional-vehicles selection web page for enabling the consumer to specify pricing requests for additional vehicles.

FIG. 19 is a user interface screen shot of a financing-offer web page for enabling the consumer to apply for financing for the selected vehicle.

FIG. 20 is a user interface screen shot of an exemplary e-mail communication from a vehicle dealer.

### DETAILED DESCRIPTION

This disclosure relates to various embodiments of systems, methods, devices, and computer software for enabling a consumer to search for vehicles-of-interest based on lifestyle categories or characteristics. It should be appreciated with reference to this disclosure that the lifestyle-based search methodologies, including any components or aspects thereof, may be implemented (although not necessarily implemented) via a computer-based system. Where desirable or appropriate given the technical or business context, certain components or aspects may be implemented via manual means or other non-computer-implemented means.

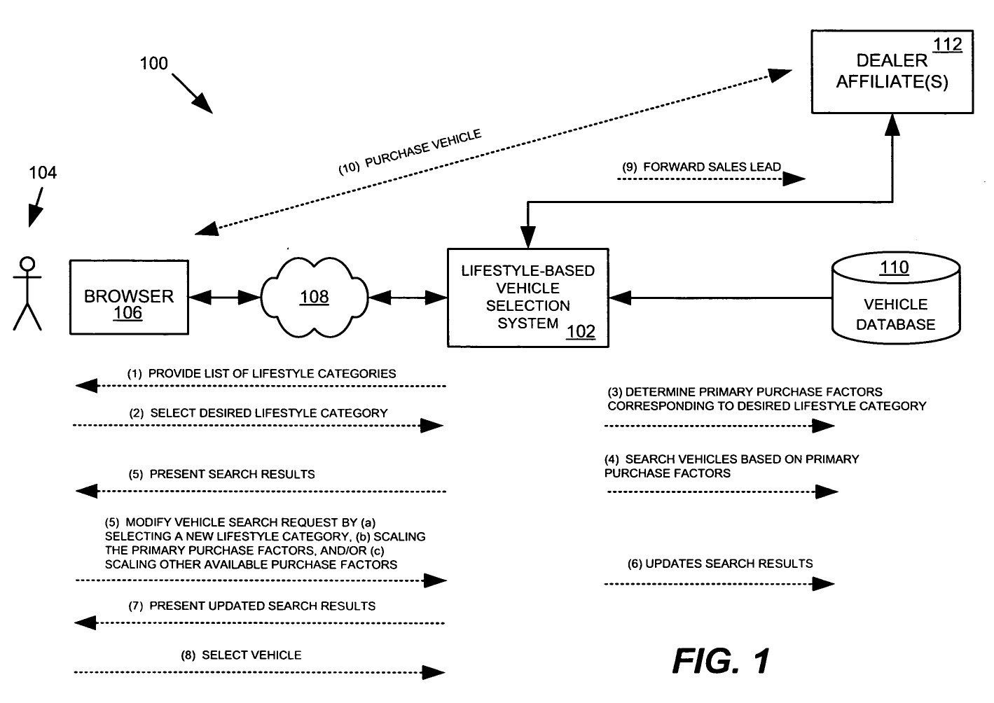

Various embodiments of lifestyle-based vehicle search systems and methods are described below in more detail with respect to FIGS. 1-20. As an introductory matter, however, an exemplary embodiment of a lifestyle-based vehicle search methodology will be briefly described. In the exemplary embodiment, the lifestyle-based vehicle search methodology enables a consumer to search for vehicles by selecting desirable “lifestyle characteristic(s)”, as reflected in identifiable vehicle purchasing behavior, rather than mechanical or physical characteristics of vehicles. The term “lifestyle characteristics” refers to identifiable attitudes, values, opinions, and patterns of behavior of an individual or group of individuals based on, for example, personal choice, influenced by the individual's personal characteristics, their social interactions, and socioeconomic and environmental factors. The lifestyle-based vehicle search methodology may incorporate any suitable lifestyle categories identified according to, for example, the results of market-based research and which match target consumers. It should be appreciated that the lifestyle-based vehicle search methodology provides a unique, alternative vehicle selection process that may be perceived as more beneficial and user-friendly to certain market segments of vehicle consumers because it removes the requirement of having to predetermine a desired make, model, or class (or other physical or mechanical vehicle properties).

In operation, a consumer selects a desired lifestyle category (or categories), perceived by the consumer to accurately reflect the consumer's wants or desires. A supporting computer system is configured to logically map the selected lifestyle category to a corresponding set of purchase factors or indicators. The supporting system may include a database of vehicle profiles, in which each vehicle is ranked according to the purchase factors or indicators (e.g., each vehicle is assigned a value or weight for each of the purchase factors or indicators). After determining the purchase factors corresponding to the selected lifestyle category, the computer system searches the database according to the purchase factors—not the selected lifestyle category—and identifies a list of top-ranked vehicles based on the purchase factors. For instance, in one embodiment, the computer system may identify a predetermined number of vehicles having the highest sum of the values or weights for the purchase factors corresponding to the selected lifestyle category. In this manner, the consumer does not have to specify the purchase factors or indicators—the system does so by mapping the selected lifestyle category to a corresponding set of purchase factors or indicators. The search process may be beneficially simplified because the consumer need only focus on his/her wants and desires by selecting a lifestyle category. The supporting system uses the selected lifestyle category to determine corresponding purchase factors or indicators, and then configures applicable search criteria and executes the search. While the end result of the vehicle search is based on purchase factors, the consumer perceives a user-friendly lifestyle-based search.

Having generally described an exemplary lifestyle-based vehicle search methodology, numerous embodiments of systems and methods for implementing a lifestyle-based vehicle search will be described with reference to FIGS. 1-20. FIG. 1 illustrates one of a number of possible embodiments of a web-based computer system 100 for implementing a lifestyle-based vehicle selection system 102. As generally illustrated in FIG. 1, consumers 104 may access lifestyle-based vehicle selection system 102 via, for example, a browser 106 which communicates via a communication network 108. Communication network 108 may be implemented with any communication medium (wired or wireless) and any known or later-developed communication technologies, architecture, protocols, etc. In one of a number of possible embodiments, communication network 108 comprises a wide area network, such as the Internet. Consumers 104 may interface with lifestyle-based vehicle selection system 102 via any suitable computer device and associated software (e.g., web browser 106). Various embodiments of lifestyle-based vehicle selection system 102 are described below in detail. In a web-based implementation, such as illustrated in FIG. 1, lifestyle-based vehicle selection system 102 may comprise a server, such as, a web server, or multiple connected servers configured to communicate via communication network 108.

As further illustrated in the embodiment of FIG. 1, lifestyle-based vehicle selection system 102 may also provide an interface with dealer affiliate(s) 112, either via communication network 108 or otherwise. Dealer affiliate(s) 112 may comprise business entities affiliated with a service provider of lifestyle-based vehicle selection system 102. Dealer affiliates 112 may comprise a brick-and-mortar vehicle retailer, an on-line dealer, or an on-line vehicle research site to name a few. Computer system 100 comprises a vehicle database 110 (which may be integrated with lifestyle-based vehicle selection system 102 or provided as an external component or service accessed via, for example, communication network 108).

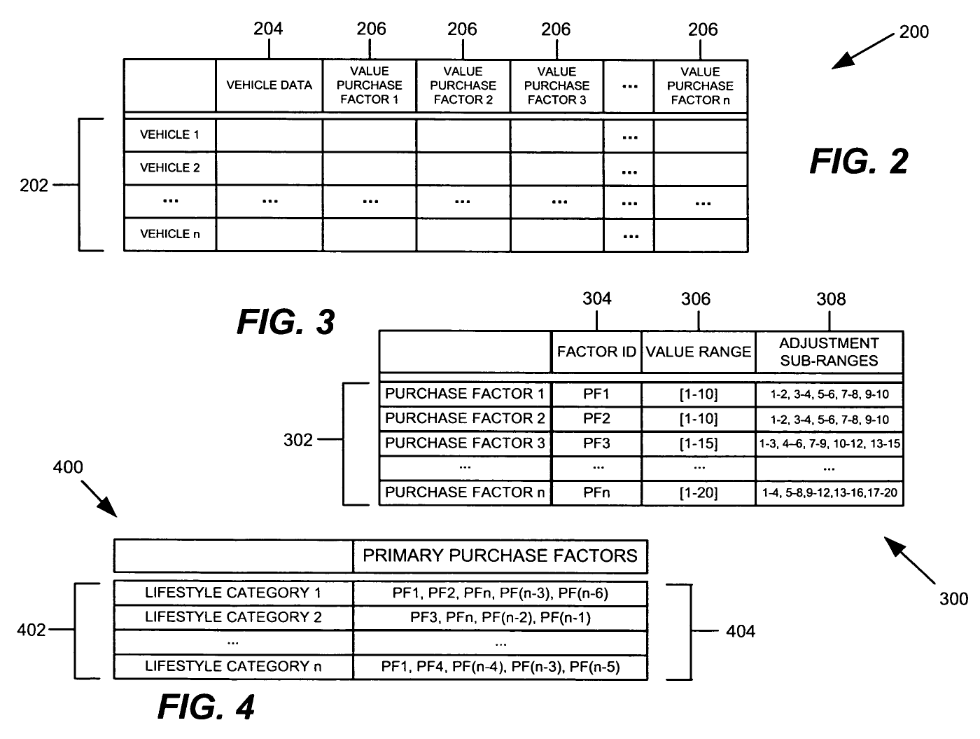

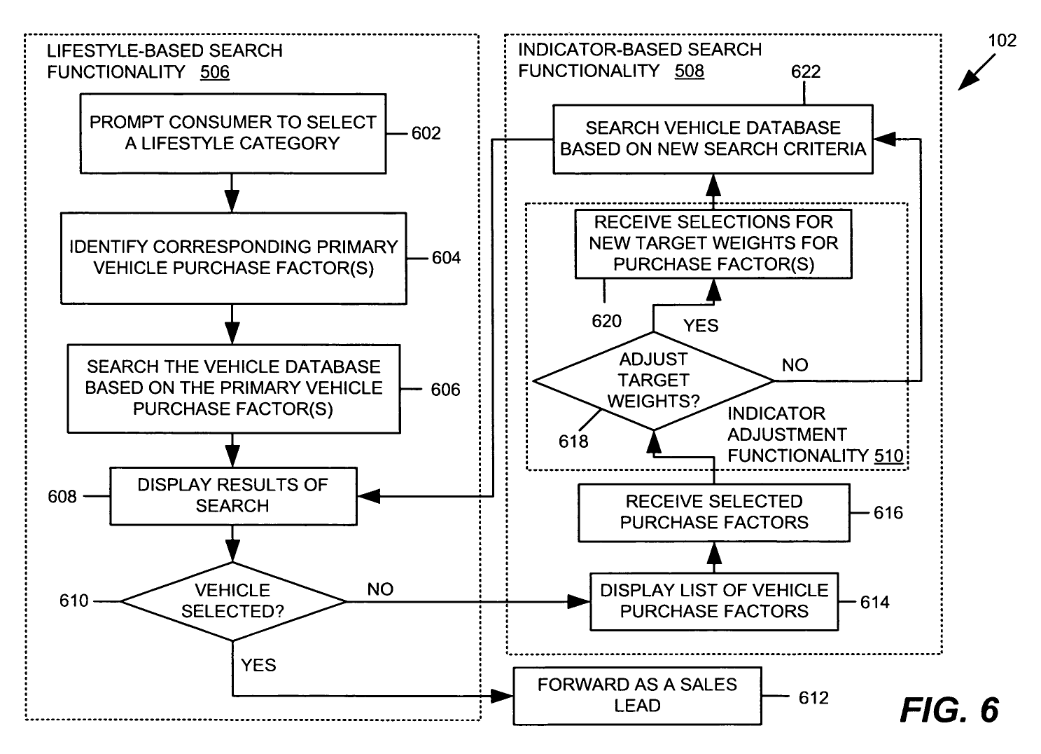

In general, vehicle database 110 stores information for a plurality of vehicles. As illustrated in FIG. 2, vehicle database 110 may store a plurality of vehicle profiles 202, each of which stores information associated with a particular vehicle. Vehicle profiles 202 comprise vehicle data 204 identifying various types of information about the corresponding vehicle. For instance, vehicle data 204 may include make/model/class data, MSRP data, or any other useful information related to vehicles. Vehicle profiles 202 may also include data values 206 for each of a plurality of purchase factors or indicators. Each vehicle is ranked according to the purchase factors or indicators by, for example, assigning a value or weight for each factor or indicator. In one embodiment, as illustrated in FIG. 3, vehicle profiles 202 may include values or weights for a plurality of purchase factors 302. Each factor 302 may comprise a unique identifying factor ID 304, a value range 306, and one or more adjustment sub-ranges 308. Value range 306 defines the available values for assigning to any particular vehicle. The value range may be numerical (e.g., using integers, whole numbers, real numbers, etc.) or may comprise a Boolean or other variable. It should be appreciated that any desirable ranking scheme may be implemented. Adjustment sub-ranges 308 comprise a sub-set of values within a corresponding value range. For example, consider a value range 306 comprising the set of integers 1-15, which may have a set of five adjustment sub-ranges 308: 1-3, 4-6; 7-9; 10-12; 13-15. As described below in more detail with respect to FIGS. 6 & 7, adjustment sub-ranges 308 may be used in connection with an indicator-based vehicle search (as opposed to a lifestyle-based vehicle search using lifestyle categories). Consumer 104 may initiate an indicator-based vehicle search by selecting one or more target purchase factors 302. In one embodiment, a default indicator-based vehicle search may be configured to search for vehicle profiles 202 having higher values or weights for the selected purchase factors. Alternatively, adjustment sub-ranges 308 may be used to select a target range of values.

In one of a number of possible embodiments, lifestyle-based vehicle selection system 102 implements a set of fifteen purchase factors 302, each having a numerical value of 1-10 points, yielding a maximum of 150 points and a minimum of 15 points for any given vehicle profile 202. Quantitative values may be developed for each purchase factor or indicator to ensure consistency across the range of vehicles available in vehicle database 110. For example, two or more editors may develop ratings for any specific vehicle. This may be an evolving system, based on internal research, or may incorporate third-party rankings (e.g., industry ratings, proprietary ratings, etc.). The set of fifteen purchase factors 302 are described below.

1. Safety Indicator

Public Description: The safety rating may be based on several important factors. For example, a primary factor may be based on an industry standards, such as the National Highway Traffic Safety Administration (NHTSA) crash test data. NHTSA data is based on five tests: front driver, front passenger, front seat side, rear seat side, and rollover. Additional safety factors may include tip-up occurrences in emergency avoidance tests and the safety equipment found on each individual vehicle. A tip-up in the emergency avoidance test may result in a default minimum rating (e.g., a two-star rating).

Editorial Method: Average the five star-ratings done by the NHTSA to figure an average overall safety rating. Always use the lowest safety rating for any particular trim. At the editor's discretion, the safety rating can be raised or lowered based on standard or optional equipment and other third-party data such as Consumer Reports. A tip-up during any emergency avoidance test results in a rating not to exceed a “6” on the Autotropolis scale due to instability during high-speed avoidance maneuvers.

Table 1 below illustrates an example of a value range 306 and adjustment sub-ranges 308 for an embodiment of a safety indicator.

TABLE 1
Example Safety Indicator Data

| NHTSA Stars: | Base Rating |
|---|---|
| 1 | 0 |
| 1.5 | 1 |
| 2 | 3 |
| 2.5 | 5 |
| 3 | 7 |
| 3.5 | 9 |
| 4 | 11 |
| 4.5 | 13 |
| 5 | 15 |
| Equipment | Varies |
| Tip-Up | Maximum Rating of 6 |

Safety Slider Scale

| Rating | Slider Display |
|---|---|
| 1-3 | * |
| 4-6 | ** |
| 7-9 | *** |
| 10-12 | **** |
| 13-15 | ***** |

2. Reliability Indicator

Public Description: Reliability ratings may be based on, for example, recall information, technical service bulletins, reliability studies, and/or other third-party data to create an overall view of the reliability of a make and model.

Editorial Method: There are a number of industry standards related to reliability that may be employed. However, because reliability can significantly vary between two vehicles of the same exact make and model, in one embodiment, the reliability indicator is simplified according to data from a single source (e.g., Consumer Reports data) to offer a reliability baseline.

Table 2 below illustrates an example of a value range 306 and adjustment sub-ranges 308 for an embodiment of a reliability indicator.

TABLE 2
Example Reliability Indicator Data

| Consumer Reports | Autotropolis Rating |
|---|---|
| 5 | 13-15 |
| 4 | 10-12 |
| 3 | 7-9 |
| 2 | 4-6 |
| 1 | 1-3 |

Reliability Slider Scale

| Rating | Slider Display |
|---|---|
| 1-3 | Not Reliable |
| 4-6 | Poor Reliability |
| 7-9 | Average Reliability |
| 10-12 | Reliable |
| 13-15 | Very Reliable |

3. Mileage Indicator

Public Description: Fuel mileage ratings may be based on Environmental Protection Agency (EPA) fuel consumption ratings. By averaging the rated city and highway mileage together to create an average mileage rating, vehicles may be rated based on what mileage a driver may experience under real-world driving conditions.

Editorial Method: Average the EPA highway and EPA city mileage and cross-reference that number to the chart below. Use the highest mileage rating available if rating a make and model range.

Table 3 below illustrates an example of a value range 306 and adjustment sub-ranges 308 for an embodiment of a mileage indicator.

TABLE 3
Example Mileage Indicator Data

| EPA Mileage | Rating |
|---|---|
| 1-4 | 1 |
| 5-9 | 2 |
| 10-14 | 3 |
| 15-19 | 4 |
| 20-24 | 5 |
| 25-29 | 6 (27.5 is the CAFE average) |
| 30-34 | 7 |
| 35-39 | 8 |
| 40-44 | 9 |
| 45-49 | 10 |
| 50-54 | 11 |
| 55-59 | 12 |
| 60-64 | 13 |
| 65-69 | 14 |
| 70+ | 15 |

Mileage Slider Scale

| Slider | Display Rating |
|---|---|
| 1-4 | 1 |
| 5-9 | 2 |
| 10-14 | 3 |
| 15-19 | 4 |
| 20-24 | 5 |
| 25-29 | 6 |
| 30-34 | 7 |
| 35-39 | 8 |
| 40-44 | 9 |
| 45-49 | 10 |
| 50-54 | 11 |
| 55-59 | 12 |
| 60-64 | 13 |
| 65-69 | 14 |
| 70+ | 15 |

4. Style Indicator

Public Description: The style rating measures curb appeal, the age of the design, badge engineering gone wrong, the overall “cool” factor, uniqueness, sophistication, and sexiness of a vehicle. Depending on what you are looking for in a vehicle, the definition of style can be a very individual thing. Try different style settings on the slider to find the vehicle that appeal to your sense of style.

Editorial Method: The style rating is a subjective measurement of curb appeal, age of the design, badge engineering, “cool” factor, sophistication and/or sexiness. The following guidelines can be used as a starting point, but given the subjective nature of the indicator, editors can use their judgment.

Table 4 below illustrates an example of a value range 306 and adjustment sub-ranges 308 for an embodiment of a style indicator.

TABLE 4
Example Style Indicator Data

| J.D. Power “Appeal” | Rating |
|---|---|
| No Rating | +3 |
| 1 | +0 |
| 2 | +1 |
| 3 | +3 |
| 4 | +5 |
| 5 | +7 |
| Body design is over 3 years old: | −2 |
| Celebrity Drive | +1 |
| Considered a Halo Car | +1 |
| Considered a Supercar | +1 |
| Considered a Luxury Car | +1 |
| Badge Engineered Copy | −1 |
| General Appearance | Editor's Choice |

Style Slider Scale

| Rating | Slider Display |
|---|---|
| 1-3 | Very Conservative |
| 4-6 | Conservative |
| 7-9 | Moderate |
| 10-12 | Stylish |
| 13-15 | Very Stylish |

5. Price Indicator

Public Description: Rate price based on the MSRP of a mid-line trim of a particular make and model. The MSRP is compared to the most recent Comerica average selling price index and the difference between the Comerica average and the MSRP determines the overall rating. Because the price threshold can only be determined by you, the car buyer, we recommend setting this slider to the highest price you are comfortable paying and then begin exploring your car buying options by utilizing the other sliders to find the car that is right for you based on your target price.

Editorial Method: Compare the MSRP of the selected vehicle and trim to the chart below. When ranking an entire model line, choose a mid-line trim.

Table 5 below illustrates an example of a value range 306 and adjustment sub-ranges 308 for an embodiment of a price indicator.

TABLE 5
Example Price Indicator Data

| Rating | Vehicle MSRP |
|---|---|
| 15 | $1-$17,958 |
| 14 | $17,959-$20,458 |
| 13 | $20,459-$22,958 |
| 12 | $22,959-$25,458 |
| 11 | $24,459-$27,458 |
| 10 | $27,459-$27,958 |
| 9 | $27,959-$27,458 |
| 8 | $27,459-$30,958 |
| 7 | $30,959-$33,458 |
| 6 | $33,459-$33,958 |
| 5 | $33,959-$38,458 |
| 4 | $38,459-$40,958 |
| 3 | $40,958-$43,458 |
| 2 | $43,457-$45,958 |
| 1 | $45,959+ |

Price Slider Scale

| Rating | Slider Display |
|---|---|
| 15 | 1-17958 |
| 14 | 17959-20458 |
| 13 | 20459-22958 |
| 12 | 22959-25458 |
| 11 | 24459-27458 |
| 10 | 27459-27958 |
| 9 | 27959-27458 |
| 8 | 27459-30958 |
| 7 | 30959-33458 |
| 6 | 33459-33958 |
| 5 | 33959-38458 |
| 4 | 38459-40958 |
| 3 | 40958-43458 |
| 2 | 43457-45958 |
| 1 | 45959+ |

6. Cost-of-Ownership Indicator

Public Description: The cost-of-ownership rating is based on the ongoing maintenance needs of a make and model by including the cost of routine maintenance, consumables such as tires and fluids, insurance, and resale value of the vehicle. The Environmental Protection Agency (EPA) average mileage figure also contributes to the cost-of-ownership.

Editorial Method: There is a great deal of industry data available. The following charts can be used to estimate a cost-of-ownership rating.

Table 6 below illustrates an example of a value range 306 and adjustment sub-ranges 308 for an embodiment of a cost-of-ownership indicator.

TABLE 6
Example Cost-of-Ownership Indicator Data

| EPA Mileage | Base Rating |
|---|---|
| 9 or Less | 6 |
| 10-14 | 7 |
| 15-19 | 8 |
| 20-24 | 9 |
| 25-29 | 11 (27.5 is the CAFÉ average) |
| 30-34 | 12 |
| 35-39 | 13 |
| 40+ | 14 |

| | |
|---|---|
| Insurance Costs | Maintenance Estimates |

| | | | |
|---|---|---|---|
| Very Low | +2 | Very Low | +2 |
| Low | +1 | Low | +1 |
| Average | 0 | Average | 0 |
| High | −1 | High | −1 |
| Excessive | −2 | Excessive | −2 |

Resale Value Estimates

| | |
|---|---|
| Very Low | −2 |
| Low | −1 |
| Average | 0 |
| High | +1 |
| Very High | +2 |

Cost-of-Ownership Slider Scale

| Rating | Slider Display |
|---|---|
| 1-3 | Very High |
| 4-6 | High |
| 7-9 | Average |
| 10-12 | Low |
| 13-15 | Very Low |

7. Fit-and-Finish Indicator

Public Description: Fit and finish can be described as the quality of the details; all of the little things that add up to give an impression of quality or shoddiness. The overall fit and finish of the vehicle can include paint consistency, panel gaps, and the quality of trim, knobs, handles, and body cladding. In a vehicle with poor fit and finish, the interior details could be flimsy, the panel gaps may be misaligned, or generally “cheap” feeling materials may have been used. In a vehicle with an excellent fit and finish, the materials will be of high quality, the panel gaps and other tolerances will be precise and even, and the overall details will possess a noticeable and appreciable level of quality.

Editorial Method: Editors opinion of the attributes described in the public description.

Table 7 below illustrates an example of a value range 306 and adjustment sub-ranges 308 for an embodiment of a fit-and-finish indicator.

TABLE 7
Example Fit-and-Finish Indicator Data

| Editor's Opinion | Rating |
|---|---|
| Poor | 1 |
| Excellent | 15 |

Fit and Finish Slider Scale

| Rating | Slider Display |
|---|---|
| 1-3 | Low Quality |
| 4-6 | Below Average |
| 7-9 | Average |
| 10-12 | Above Average |
| 13-15 | High Quality |

8. Drive System Indicator

Public Description: The drive system rating indicates which drive layout the vehicle features. For example, the six common drive configurations are rear-wheel-drive (RWD), front-wheel-drive (FWD), RWD or FWD with traction control, all-wheel-drive (AWD), four-wheel-driver (FWD), and four-wheel-drive with locking differential.

Editorial Method: Use the highest rating for any make and model.

Table 8 below illustrates an example of a value range 306 and adjustment sub-ranges 308 for an embodiment of a drive system indicator.

TABLE 8
Example Drive System Indicator Data

| Drive | Rating |
|---|---|
| 2WD/Rear | 2 |
| 2WD/Front | 4 |
| Traction Control | 6 |
| All-Wheel-Drive | 8 |
| Four-Wheel-Drive | 10 |
| Four-Wheel-Drive w/Locker | 15 |

Drive System Slider Scale

| Rating | Slider Display |
|---|---|
| 1-2 | Rear Wheel Drive |
| 3-5 | Front Wheel Drive |
| 6-7 | Traction Control |
| 8-9 | All Wheel Drive |
| 10-13 | Four Wheel Drive |
| 14-15 | FWD with Locker |

9. Connectivity Indicator

Public Description: Our vehicles are now catching up with the connectivity we enjoy at home and work. The connectivity rating is a measurement of a vehicles level of technology, including global positioning systems, entertainment systems, navigation systems, DVD players, MP3 players, OnStar by GM, BMW Assist™, and other services and devices of this nature.

Editorial Method: Use the following chart as a basis and adjust based on individual vehicle standard and optional equipment.

Table 9 below illustrates an example of a value range 306 and adjustment sub-ranges 308 for an embodiment of a connectivity indicator.

TABLE 9
Example Connectivity Indicator Data

| | |
|---|---|
| Base Rating | 5 |

| Available Features | Rating |
|---|---|
| OnStar by GM (or similar) | +5 |
| GPS/Mapping | +2 |
| On-board DVD/Entertainment | +1 |
| On-board MP3/Digital Music | +1 |
| Satellite Radio | +1 |

Connectivity Slider Scale

| Rating | Slider Display |
|---|---|
| 1-3 | Not Connected |
| 4-6 | Limited Connectivity |
| 7-9 | Average |
| 10-12 | Good Connectivity |
| 13-15 | Excellent Connectivity |

10. Performance Indicator

Public Description: Performance is based on horsepower ratings, engine options, zero-to-sixty times, braking distance, top speed, torque, handling, cornering, and other attributes.

Editorial Method: Editors opinion of the attributes described in the public description.

Table 10 below illustrates an example of a value range 306 and adjustment sub-ranges 308 for an embodiment of a performance indicator.

TABLE 10
Example Performance Indicator Data

| Indicator | Rating |
|---|---|
| Editors Opinion | 1-15 |

Performance Slider Scale

| Rating | Slider Display |
|---|---|
| 1-3 | Lackluster |
| 4-6 | Uninspired |
| 7-9 | Average |
| 10-12 | Sporty |
| 13-15 | High Performance |

11. Warranty Indicator

Public Description: Vehicle warranties vary greatly between manufacturers. The warranty rating is based on the warranty term, the number of miles covered by the warranty, and additional coverage such as roadside assistance and the length of the corrosion and drive train warranties.

Editorial Method: Use the following additive chart based on bumper-to-bumper warranty term, warranty miles, and additional coverage.

Table 10 below illustrates an example of a value range 306 and adjustment sub-ranges 308 for an embodiment of a warranty indicator.

TABLE 11
Example Warranty Indicator Data

| Warranty Term | Rating |
|---|---|
| 3 Year | +2 |
| 4 Year | +4 |
| 5 Year | +6 |
| Warranty Miles | |
| Under 35,999 | −3 |
| 36,000-49,999 | +3 |
| 50,000+ | +5 |
| Additional Coverage | |
| No Roadside Assistance: | −1 |
| Roadside Assistance: | +1 |
| Corrosion Under 5 Years: | −3 |
| Corrosion 5 Years: | +1 |
| Corrosion Over 5 Years: | +2 |

Warranty Slider Scale

| Rating | Slider Display |
|---|---|
| 1-3 | Limited Coverage |
| 4-6 | Below Average |
| 7-9 | Average Coverage |
| 10-12 | Above Average |
| 13-15 | Best Coverage |

12. Drivability-and-Comfort Indicator

Public Description: The drivability of a car is determined by factors such as visibility, turning radius, ease-of-parking, routine handling, suspension quality, easy to use controls, and other similar factors. The comfort of a vehicle is determined by seat configuration, wind noise, ride quality, control placement, sound quality, and other similar factors.

Editorial Method: Editors opinion of the attributes described in the public description.

Table 12 below illustrates an example of a value range 306 and adjustment sub-ranges 308 for an embodiment of a drive-and-comfort indicator.

TABLE 12
Example Drive-and-Comfort Indicator Data

| Indicator | Rating |
|---|---|
| Editors Opinion | 1-15 |

Drivability Slider Scale

| Rating | Slider Display |
|---|---|
| 1-3 | Rough/Spartan |
| 4-6 | Below Average |
| 7-9 | Average |
| 10-12 | Above Average |
| 13-15 | Smooth/Luxury |

13. Child-Friendly Indicator

Public Description: The child friendly aspect of a vehicle include seating capacity, space, on-board entertainment options, number and type of doors, safety, and ease-of-use. Child-friendliness ranking are based on these factors. For example, a vehicle with a seating capacity of 6 or more adults with sliding doors will rank higher than a four-door sedan. Design features can also influence the child friendliness rankings. For example, the current placement of exterior rear door handles on some vehicles is too high for small children to reach.

Editorial Method: Below is an additive system based on safety, seating capacity, number and style of doors, and on-board entertainment. Specific design features of individual vehicles may add or subtract points based on editors' preference.

Table 13 below illustrates an example of a value range 300 and adjustment sub-ranges 308 for an embodiment of a child-friendly indicator.

TABLE 13
Example Child-Friendly Indicator Data

| Indicator | Rating |
|---|---|
| Autotropolis Safety Rating 1-5 | −3 |
| Autotropolis Safety Rating 6-12 | 0 |
| Autotropolis Safety Rating 13+ | +2 |
| 2 to 4 Passengers | −3 |
| 5 to 6 Passengers | +3 |
| 6+ Passengers | +5 |
| On-Board DVD/Entertainment | +1 |

Child Friendly Slider Scale

| Rating | Slider Display |
|---|---|
| 1-3 | Not Child Friendly |
| 4-6 | Below Average |
| 7-9 | Average |
| 10-12 | Above Average |
| 13-15 | Very Child Friendly |

14. Fuel-Selection Indicator

Public Description: There is a distinction between gas, diesel, flex-fuels, hybrids, and vehicles powered by fully electric or hydrogen power. The more advanced the fuel system, the higher the vehicle rates on our scale. If you need a vehicle with a specific fuel system, move the Fuel-Selection slider to the appropriate fuel type and adjust the other sliders per your individual specifications to choose the best vehicle in that fuel category.

Editorial Method: The fuel selection rating is based on all available engines for any particular model. If the model has the capability to be purchased with any corresponding fuel system on the chart below, the vehicle should be rated as high as possible.

Table 14 below illustrates an example of a value range 306 and adjustment sub-ranges 308 for an embodiment of a fuel-selection indicator.

TABLE 14
Example Fuel-Selection Indicator Data

| Fuel Options | Rating |
|---|---|
| Gas | 7 |
| Diesel | 9 |
| Flex-Fuels | 11 |
| Hybrids | 13 |
| Full-Electric/Hydrogen | 15 |

Fuel Selection Slider Scale

| Rating | Slider Display |
|---|---|
| 1-8 | Gas |
| 9-10 | Gas or Diesel |
| 11-12 | Flex-Fuels |
| 12-14 | Hybrids |
| 15 | Full-Electric/Hydrogen |

15. Towing Indicator

Public Description: The towing ratings per manufacturer specifications.

Editorial Method: This one is a simple correlation between manufacturer towing capacity rating and our rating scale

Table 15 below illustrates an example of a value range 306 and adjustment sub-ranges 308 for an embodiment of a towing indicator.

TABLE 15
Example Towing Indicator Data
Towing Capacity (lbs)

| | |
|---|---|
| Under 2,499 | 1-3 |
| 2,500 to 4,999 | 4-5 |
| 5,000 to 7,499 | 6-7 |
| 7,500 to 9,999 | 8-9 |
| 10,000 to 12,499 | 10-11 |
| 12,500 to 14,999 | 12-13 |
| 15,000+ | 14-15 |

Towing Slider Scale

| Rating | Slider Display (pounds) |
|---|---|
| 1-3 | Not Recommended |
| 4-5 | 2,500-5,000 |
| 6-7 | 5,000-7,500 |
| 8-9 | 7, 500-10,000 |
| 10-11 | 10,000-12,500 |
| 12-13 | 12,500-15,000 |
| 14-15 | 15,000+ |

In another embodiment, the above-referenced set of fifteen purchase factors 302 may implemented with the following set of lifestyle categories 402 and descriptions (and corresponding primary purchase factors 404):

Family Vehicle

Whether it be at home or on the road, every family needs space. There never seems to be enough of it. In addition to space, you want your family and friends to be as safe as possible. And to top things off, you need reliability and worry-free driving without breaking the bank.

PRIMARY PURCHASE FACTORS

Safety
Reliability
Mileage
Child Friendly
Cost of Ownership

Long-Distance Traveler

You are on the road almost every day. You drive more miles than some over-the-road truckers and you need a car that isn't going to make you stop every few miles to stretch your legs. You are in it for the long haul, and you car must be too. Reliability, safety, and comfort are a must; and the more mileage the better.

PRIMARY PURCHASE FACTORS

Mileage
Drivability & Comfort
Warranty
Reliability
Safety

Second Car

This might be the second or third vehicle for your family, something inexpensive but reliable. Perhaps the kids are starting to drive and you need another vehicle in the family. Or maybe you work at home and need a safe, reliable and economical car for daily driving chores, but do not need one with all the bells and whistles.

PRIMARY PURCHASE FACTORS

Reliability
Safety
Drivability & Comfort
Price
Cost of Ownership

Towing Vehicle

You work hard, you play hard. Your truck must be right there beside you every mile of the way. Whether it's hauling a load of drywall to the job site or towing your camper to the lake house, your vehicle has to perform day-in and day-out. Top of the line payload and towing capacities are a given, but you also need reliability, performance, and while your lifestyle may be hard on your trucks, your truck can't be hard on your wallet.

PRIMARY PURCHASE FACTORS

Payload & Towing
Reliability
Performance
Cost of Ownership
Warranty

First Time Car Owner

How exciting! You're shopping for your first car and while you're excited, you're reasonable. You want your first car to be that special car you are going to remember for the rest of your life. Your uncle's hand me down from the 1980s just isn't going to cut it, and you are shopping for not only style, but also worry-free ownership that won't leave you high and dry.

PRIMARY PURCHASE FACTORS

Price
Style
Warranty
Cost of Ownership
Mileage

College Driver

Just because you are on a budget doesn't mean you have to sacrifice style and reliability. You're needs are much like those of the first time buyer. You want a car with a bit of style but one that will leave enough cash in the bank to pay for text books and the occasional visit back to your hometown. A low cost of ownership and reliability are key factors. You want worry-free driving with a car you're not afraid to be seen in.

PRIMARY PURCHASE FACTORS

Price
Reliability
Style
Cost of Ownership
Mileage

Senior Driver

When you shop for a car, you're more about the creature comforts; the finer things, yet down-to-earth. And while performance is good, a car that's easy to live with, safe, and reliability are better. In short, you want a car that's comfortable, drivable, and reliable. Enough room for the grandkids and enough luggage space for the trips to all the places you wanted to visit are also a plus.

PRIMARY PURCHASE FACTORS

Drivability & Comfort
Reliability
Safety
Cost of Ownership
Child Friendly

Price is No Object

The deal is sealed. You are at the top of your game. Your company is doing great and it's time you rewarded yourself for years of hard work. Price means nothing. It's all about quality, style, and performance. You're willing to put up with a little trouble from your new baby, but you didn't get where you are by throwing money away. Reliability is also important.

PRIMARY PURCHASE FACTORS

Fit & Finish
Drivability & Comfort
Performance
Style
Reliability

Flash & Style

It's all about the show. You need a car that will get you there not only in style, but also in a hurry. You're connected, so technology is important, but so are the small things that make your car stand out. You'll spend thousands of dollars taking care of your car and will likely spend thousands more adding your own special touches. There's no point in buying a car that doesn't exude quality and performance right on the showroom floor.

PRIMARY PURCHASE FACTORS

Style
Performance
Fit & Finish
Connectivity
Drivability & Comfort

Working Vehicle

You put a lot of miles on your vehicle. You are out in all kinds of weather. Your customers depend on you to be there when they need you. That means you depend on your car for your livelihood. Not only does your car-of-choice need to be reliable, it needs to be rugged and easy to maintain

PRIMARY PURCHASE FACTORS

Payload & Towing
Reliability
Mileage
Drive System
Cost of Ownership

Off-Road

Four-wheel-drive is good. Four-wheel-drive with locker is better. You need performance, Drive System, and enough towing ability to get your toys into the rough. Your vehicle can be the difference between a fun afternoon on the trail or a long, hot walk back to the main road, so reliability is a must. So is safety. You never know what might be around the next bend.

PRIMARY PURCHASE FACTORS

Drive System
Performance
Reliability
Payload & Towing
Safety

Frugal Driver

A car is an appliance. It gets you from point-A to point-B and it spends 95% of its life in the garage anyway, so why buy a fancy or expensive car? You need a car that's not going to cost you a small fortune. The car needs to be both economical to purchase and economical when it comes time for service and maintenance.

PRIMARY PURCHASE FACTORS

Price
Warranty
Reliability
Mileage
Cost of Ownership

Executive

You've made it. The promotion to VP just came through and it's time to celebrate with a bit of automotive indulgence. Style, quality, performance, and comfort are the hallmarks you desire in a vehicle. Price means little. You've earned the best through hard work, destination, and excellence. Your co-workers, customers, and clients will see that you've made it to the top when you buy the best.

PRIMARY PURCHASE FACTORS

Style
Fit & Finish
Performance
Connectivity
Drivability & Comfort

Understated Luxury/Performance

Leave the flash to the celebrities, you're beyond that. You want to know you can feel secure that you paid the right price for the right car. Style is important, but you also demand fit and finish, performance, drivability, and comfort. You like knowing the power is on tap, even if you never use it. It's the comfort and the sophisticated style that you crave. We'll help you find it.

PRIMARY PURCHASE FACTORS

Style
Fit & Finish
Performance
Price
Drivability & Comfort

Performance Driver

Performance is what you live for. Not just top speed, but handling, cornering, and braking distances. You read your owners manual cover-to-cover and memorized the performance specifications of at least a dozen cars. You know that your car is also a reflection of you. Not any old piece of iron will get your pulse going. It has to be special. It has to have style.

PRIMARY PURCHASE FACTORS

Performance
Style
Drive System
Fit & Finish
Reliability

Safety Conscious

It can be a dangerous world and there's little point to buying a vehicle that does not provide the maximum in safety. You want yourself, your family, and your friends to be as safe as possible while riding in your car. It only makes sense. You need a vehicle that performs regardless of the road conditions and you need a car that won't leave you sitting by the side of the road.

PRIMARY PURCHASE FACTORS

Safety
Reliability
Drive system
Drivability & Comfort
Child Friendly

Value Buyer

You're willing to spend what it takes to get what you want, but what you buy better be the best value for the dollar. In a way, you want it all, and with the help of Autotropolis, you just might get it. Reliability, quality, and comfort for a price that won't make your 401k suffer? We have it.

PRIMARY PURCHASE FACTORS

Reliability
Price
Warranty
Fit and Finish
Drivability & Comfort

Environmentalist

The vehicle you drive must be as compatible with the needs of the environment as possible. A hybrid with great mileage, good reliability, and a low cost of ownership is ideal.

PRIMARY PURCHASE FACTORS

Mileage
Fuel Selection
Reliability
Cost of Ownership
Warranty

Referring again to FIG. 1, the general operation of an embodiment of a lifestyle-based vehicle selection method will be briefly described, as enabled by lifestyle-based vehicle selection system 102. At reference method element (1), lifestyle-based vehicle selection system 102 provides a list of lifestyle categories 402 to consumer 104 via, for example, a web session with browser 106. The lifestyle categories may be defined by lifestyle-based vehicle selection system 102 and/or dealer affiliate(s) 112, as appropriate to reflect, for example, needs, wants, or desirable lifestyle characteristics of target market segment(s). At this point, consumer 104 may also specify other search criteria, such as a price range. At reference method element (2), consumer 104 selects one or more lifestyle categories 402 via browser 106. At reference method element (3), lifestyle-based vehicle selection system 102 determines the primary purchase factors 404 corresponding to the selected lifestyle categories 402. This logical mapping may be implemented via vehicle database 110 or suitable data structures and/or associated logic. At reference method element (4), vehicle database 110 is searched based on the primary purchase factors 404 corresponding to the selected lifestyle category 402. For instance, in one embodiment, values 206 for primary purchase factors 404 are searched, and a list of matching vehicles is identified and presented to consumer 104, at reference method element (4). Various matching algorithms may be employed, but in one embodiment, a predetermined number of top-ranked vehicles are presented to consumer 104 (e.g., based on the sum of values 206 for primary purchase factors 404). At reference method element (5), consumer 104 may interface with the search results (e.g., select a vehicle). Consumer 104 may also modify the search criteria by, for example, selecting alternative lifestyle categories 402 or by adjusting or scaling primary purchase factors 404. Consumer 104 may also remove purchase factors 302 or add new ones. When adjusting or scaling purchase factors 302, consumer 104 may select a target value range based on adjustment sub-ranges 308 for the corresponding purchase factors. At reference method element (6), a new or updated search is performed based on the revised search criteria. At reference method element (7), the updated search results are presented to consumer 104. Consumer 104 may repeatedly revise the vehicle search criteria. When a desirable vehicle is located, consumer 104 may select the vehicle, at reference method element (8). Information related to the vehicle selection may be forwarded to dealer affiliate(s) 112, in the form of a sales lead for the selected vehicle, at reference method element (9). Electronic or non-electronic communications and/or other interactions between consumer 104 and dealer affiliate(s) 112 may ultimately result in a purchased vehicle—reference method element (10).

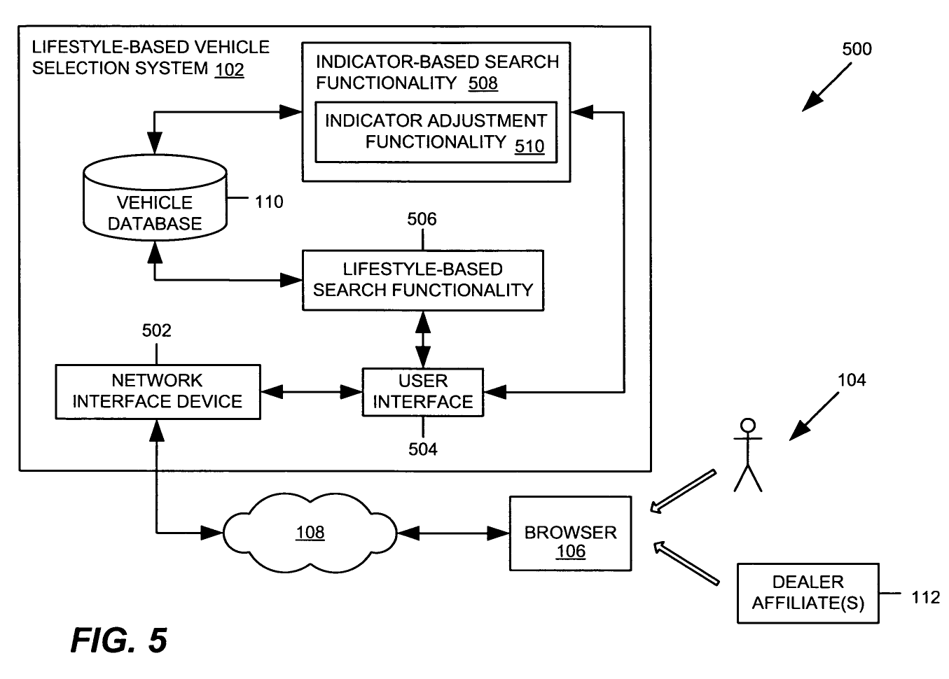

FIG. 5 illustrates another embodiment of a computer system 500 for implementing a lifestyle-based vehicle search. In the embodiment illustrated in FIG. 5, computer system 500 comprises a network interface device 502, a user interface 504, vehicle database 110, various software tools for implementing a lifestyle-based vehicle selection (e.g., lifestyle-based search functionality 506, indicator-based search functionality 508, indicator adjustment functionality 510), and one or more processors (not shown) for executing software-based tools and logic associated with lifestyle-based vehicle selection system 102.

Network interface device 502 provides a communication interface between communication network 108 and the components of lifestyle-based vehicle selection system 102. User interface device 504 enables consumers 104 to interface with the functionality of lifestyle-based vehicle selection system 102 via, for example, browser 106. User interface device 504 may comprise a web interface, a graphical user interface (GUI), or may incorporate other desirable UI designs, technologies, etc.

In general, lifestyle-based search functionality 504, indicator-based search functionality, and indicator adjustment functionality 506 comprise logic for providing the various aspects, features, functionality, etc. of the lifestyle-based vehicle selection system 102. Lifestyle-based search functionality 506 enables consumer 104 to configure a search of vehicle database 110 according to lifestyle categories 402, while indicator-based search functionality 508 enables consumer 104 to configure a search based on purchase factors 302. Indicator-adjustment functionality 510 may be incorporated as a sub-component of indicator-based search functionality 508 (as illustrated in the embodiment of FIG. 5) or as separate or integral logic element(s). Indicator-adjustment functionality 510 enables consumers 104 to adjust or scale purchase factors 302 for an initial search or a revised search of vehicle database 110.

Referring to FIG. 6, the general operation of the software-based tools will be described. As illustrated in FIG. 6, lifestyle-based search functionality 506 comprises blocks 602, 604, 606, 608, and 610, while indicator-based search functionality comprises blocks 614, 616, 618, 620, and 622 (with blocks 618 and 620 representing indicator adjustment functionality 510). It should be appreciated, however, that any process or logical descriptions of these modules (or the processes or methods steps described above) may represent modules, segments, or portions of code which include one or more executable instructions for implementing specific logical functions, steps, or acts in a process. It should be further appreciated that any logical functions may be executed out of order from that shown or discussed, including substantially concurrently or in reverse order, depending on the functionality involved, as would be understood by those reasonably skilled in the art. One of ordinary skill in the art will further appreciate that one or more of the aspects of the systems, methods, programs, etc. described above for implementing a lifestyle-based vehicle search may be implemented via a computer system, while others are manually implemented. Computer-implemented embodiments may support any communication protocol, computer language, etc. and may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the logic embodying the applicable process for use by or in connection with the instruction execution system, apparatus, or device. The computer-readable medium may be, for example, an electronic, magnetic, optical, electromagnetic, infrared, or semiconductor system, apparatus, device, or propagation medium.

Referring again to FIG. 6, at block 602, lifestyle-based search functionality 506 prompts consumer 104 to select a lifestyle category 402. Lifestyle-based search functionality 506 receives the user selection and, at block 604, identifies the primary purchase factors 404 corresponding to the selected lifestyle category. In one embodiment, this logical mapping and translation is implemented via a data structure such as illustrated in FIG. 4. At block 606, lifestyle-based search functionality 506 initiates a search of vehicle database 110 according to the primary purchase factors 404, rather than the selected lifestyle category. As mentioned above, this translation or mapping may be transparent to consumer 104 to give the perception of a more simplified search methodology that is based on wants or needs, as opposed to mechanical or physical characteristics of the vehicles. At block 608, lifestyle-based search functionality 506 displays the results of the search to consumer 104. One or more of the data elements, in vehicle profiles 202 (or other useful information) may be presented to consumer 104. The vehicle-related information may be presented in a static manner or in a dynamic or interactive manner to enable consumer 104 to view more detailed information, as well as select a vehicle to purchase or to request a vehicle quote (block 610). In this regard, at block 612, relevant information about vehicle selections or other user interactions may be forwarded to dealer affiliate(s) 112.

Lifestyle-based vehicle selection system 102 may supplement the lifestyle-based vehicle search with an indicator-based search (e.g., a search based on purchase factors 302). Traditional make/model/class searches may also be incorporated to provide consumers 104 with a variety of search options. An indicator-based search may be initiated by consumer 104 at anytime or, in one embodiment, it may be offered as a secondary, more granular search presented to consumer 104 after the initial lifestyle-based results are presented. When an indicator-based search is initiated, at block 614, a list of purchase factors 614 may be presented to consumer 614. At block 616, the user selections are received (i.e., one or more purchase factors 302). As represented by decision block 618, consumer 104 may also specify target values for the selected purchase factors. For example, consumer 104 may select a particular adjustment sub-range 308 or specify a particular target value within value range 306. The adjustment functionality may be configured as a convenient user interface mechanism, such as a slider bar, a text box, buttons, etc. If the adjustment functionality is initiated, at block 620, the user selections are received. At block 622, a revised search of vehicle database 110 is initiated, according to the selected purchase factors (block 616) and/or the target weights (block 620). Logical flow returns to block 608, which displays the search results.

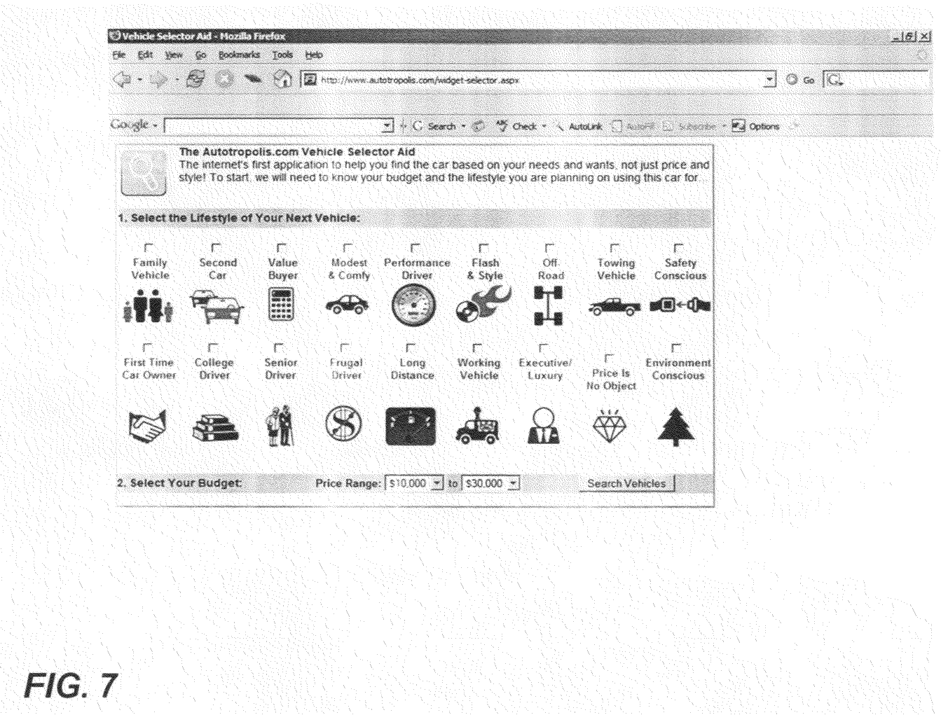

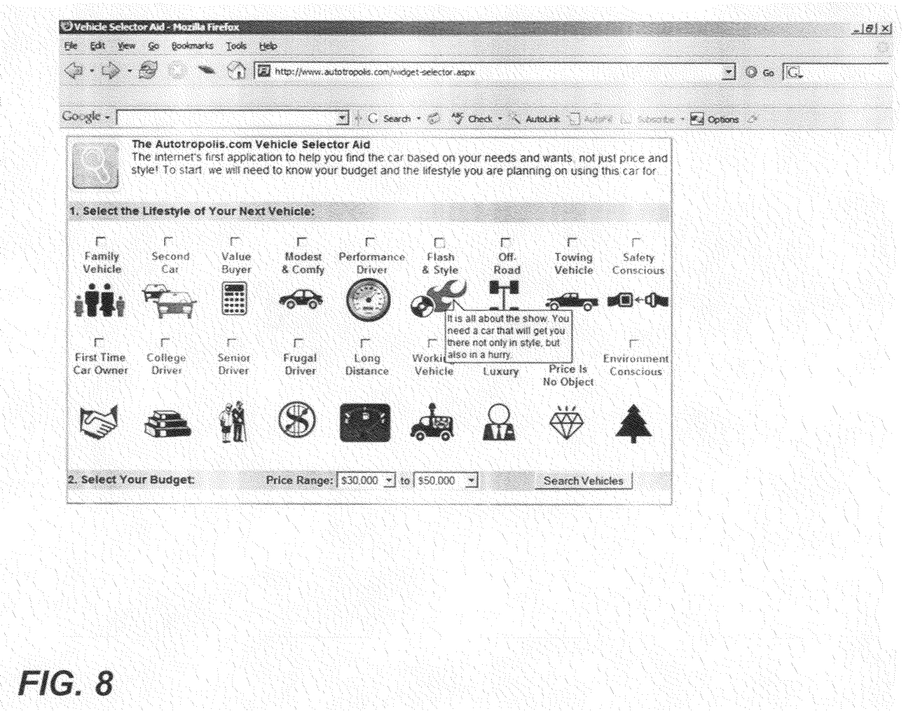

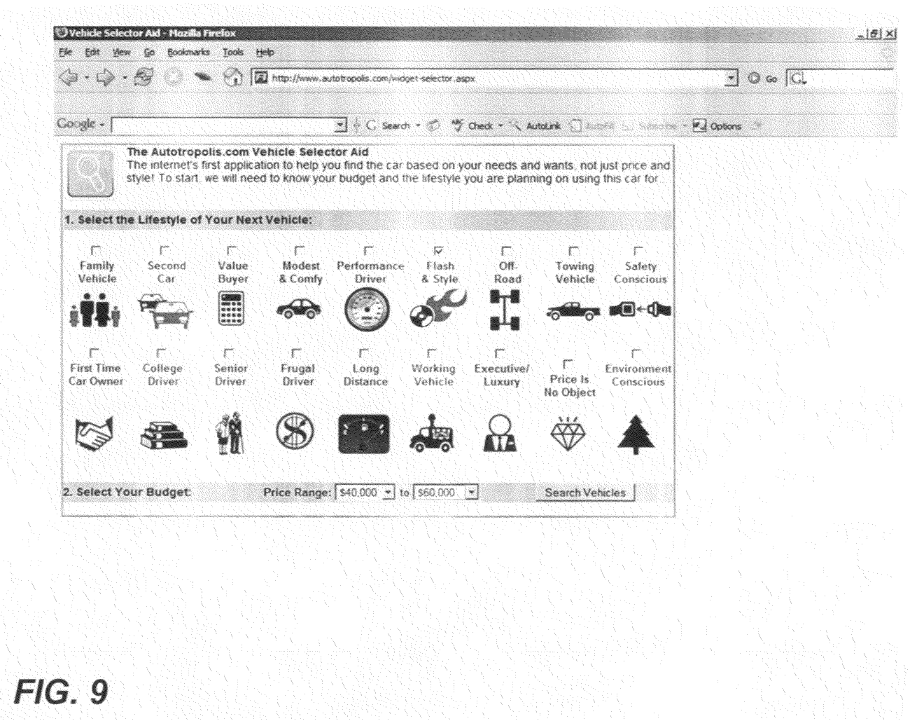

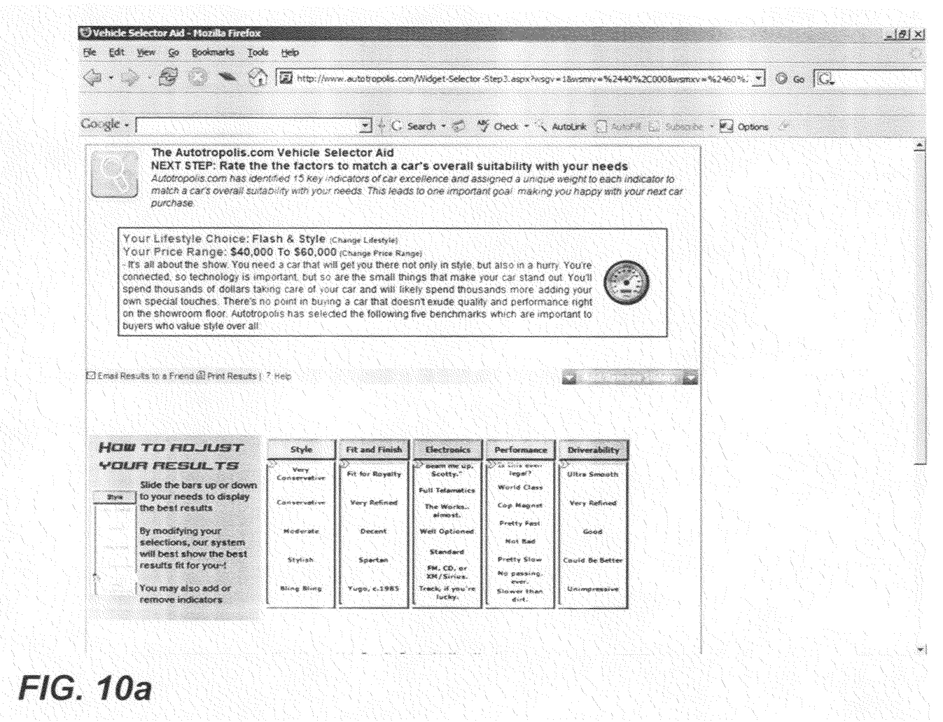

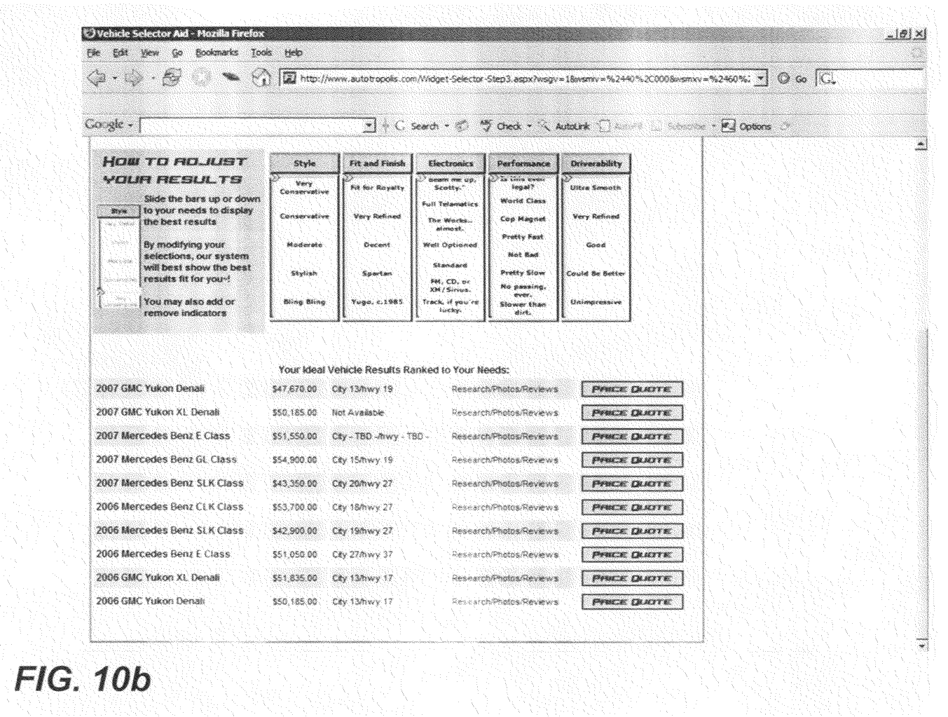

FIGS. 7-20 illustrate various screen shots of an embodiment of a web-based user interface for enabling a consumer 104 to perform a lifestyle-based vehicle search. With respect to these screen shots, the operation of a method for performing a lifestyle-based vehicle search will be described from the perspective of a consumer 104. FIG. 7 illustrates a vehicle selection web page for enabling a consumer 104 to select a lifestyle category 402 and a price range. In this embodiment, lifestyle categories 402 comprise the following: a family-car category, a second-car category, a value-buyer category, a comfortable category, a performance driver category, a style category, an off-road category, a towing-vehicle category, a safety-conscious category, a first-time-car-owner category, a college-driver category, a senior driver category, a frugal driver category, a long-distance-driving category, a working vehicle category, an executive/luxury category, a price-is-no-object category, and an environment-conscious category. As illustrated in FIG. 8, consumer 104 may perform a mouse-over function (i.e., move a cursor over the icon associated with a lifestyle category 402) to view a general description of the lifestyle characteristics. In FIG. 9, consumer 104 has selected the flash-and-style lifestyle category and selected a price range of $40,000-$60,000. FIGS. 10a and 10b illustrate the results of the database search based on the flash-and-style lifestyle category and price range. As mentioned above, prior to initiating the lifestyle-based search, the primary purchase factors 404 are determined, and the search is performed based on the primary purchase factors 404. In the results web page, the matching vehicle profiles 202 may be displayed (FIG. 10b), as well as the primary purchase factors 404 (FIG. 10a). In the illustrated embodiment, the primary purchase factors 404 associated with the flash-and-style lifestyle category comprise: a style indicator; a fit-and-finish indicator; an electronics indicator; a performance indicator; and a drivability indicator. These indicators are displayed with their accompanying sub-adjustment ranges 308. For example, the style indicator comprises five adjustment sub-ranges 308—very conservative, conservative, moderate, stylish, and “bling bling”. The initial lifestyle-based search may be based on maximum default values for the primary purchase factors 404.

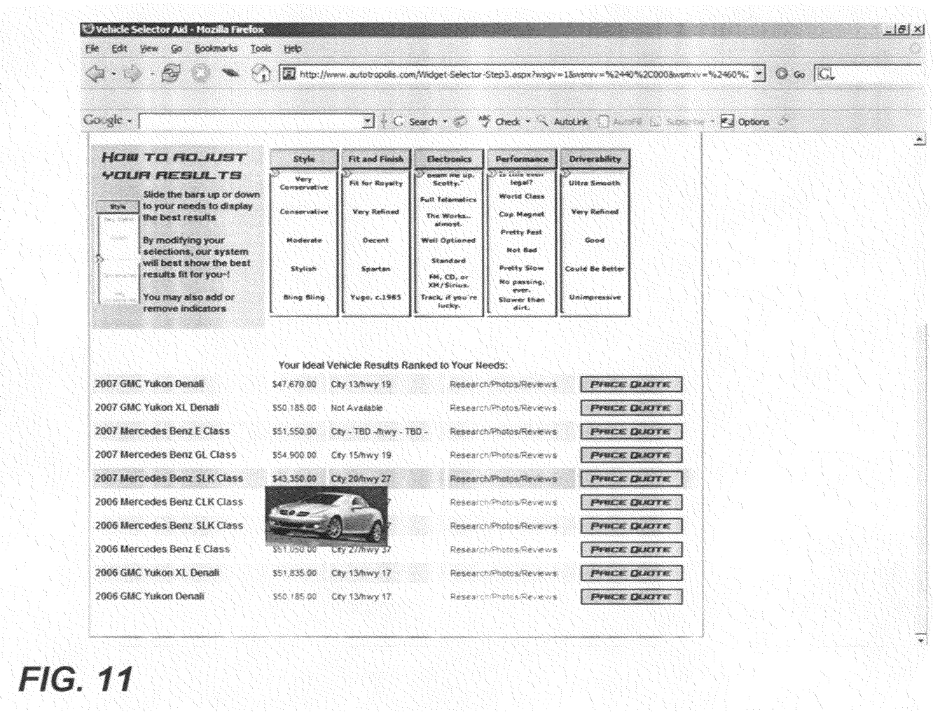

Consumer 104 may select any of the vehicles listed in the results page. In FIG. 11, consumer 104 has highlighted the “2007 Mercedes Benz SLK Class”. Various forms of vehicle information may be displayed in connection with the vehicle (e.g., price, mileage, etc.). Other UI elements may be included, as well, such as links to additional research resources, photos, reviews, and price quotes.

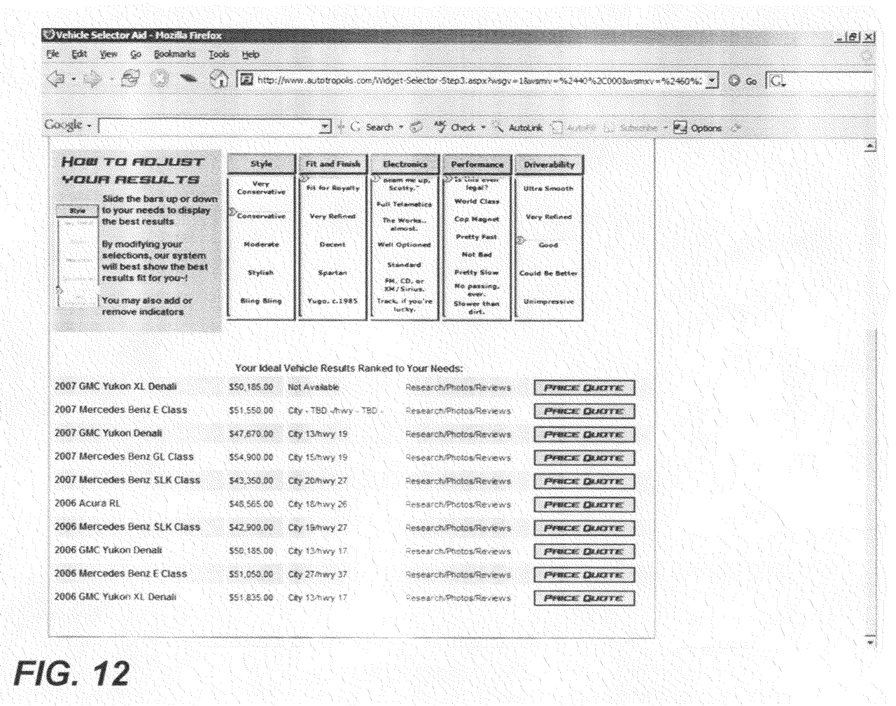

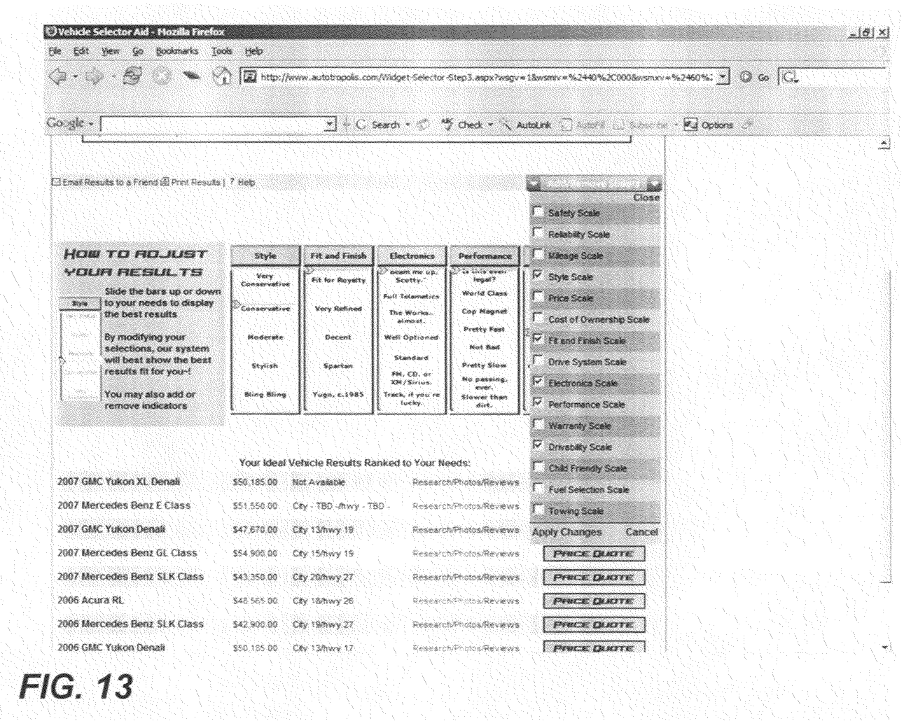

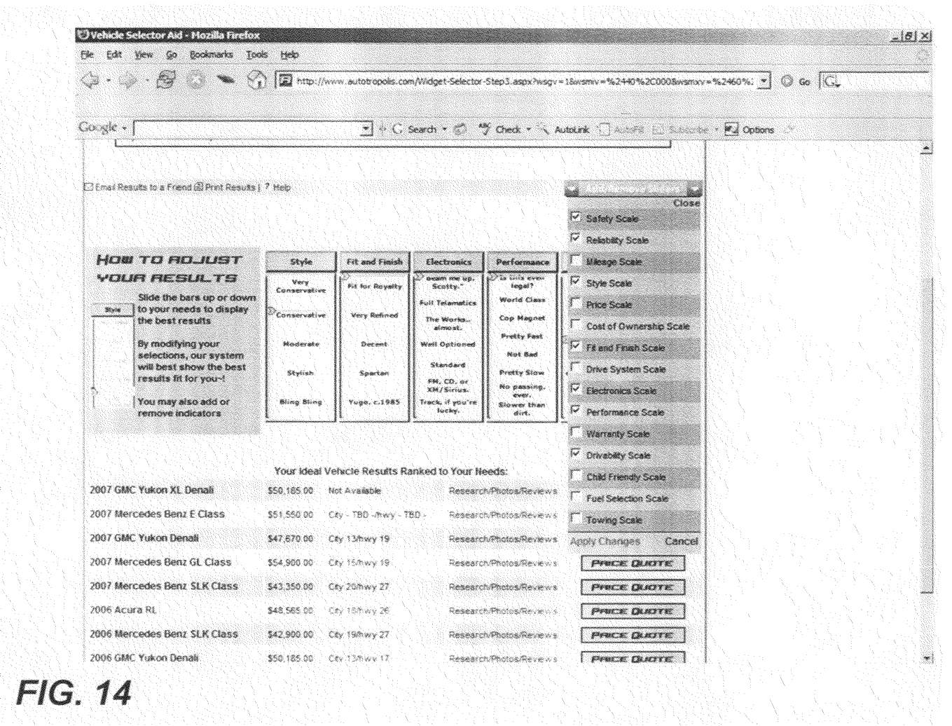

It should be appreciated that by displaying the primary purchase factors 404 and associated adjustment sub-ranges 308 in connection with the matching vehicles (FIG. 12), consumer 104 may gain further insight into the characteristics of the lifestyle category. Having evaluated the matching vehicles and the primary purchase factors 404, consumer 104 may adjust the search criteria. For example, in FIG. 12, consumer 104 uses the slider adjustment mechanism to select the “conservative” adjustment sub-range 308 for the style indicator and the “good” adjustment sub-range 308 for the drivability indicator. As illustrated in FIG. 13, consumer 104 may select an “add/remove sliders” functionality, which displays a list of the purchase factors 302. In the illustrated embodiment, the primary purchase factors 404 corresponding to the selected lifestyle category 402 are initially “checked” to show the initial search criteria. Consumer 104 may check or uncheck any of the listed purchase factors 302. In FIG. 14, consumer 104 has selected two new purchase factors 302 for a revised search—the safety indicator and the reliability indicator.

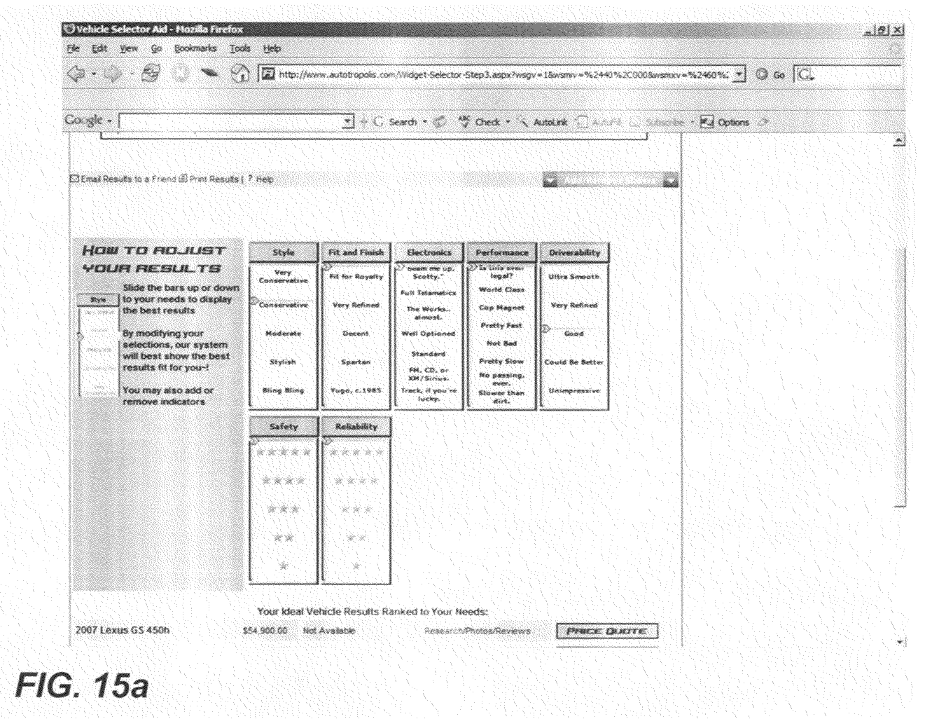

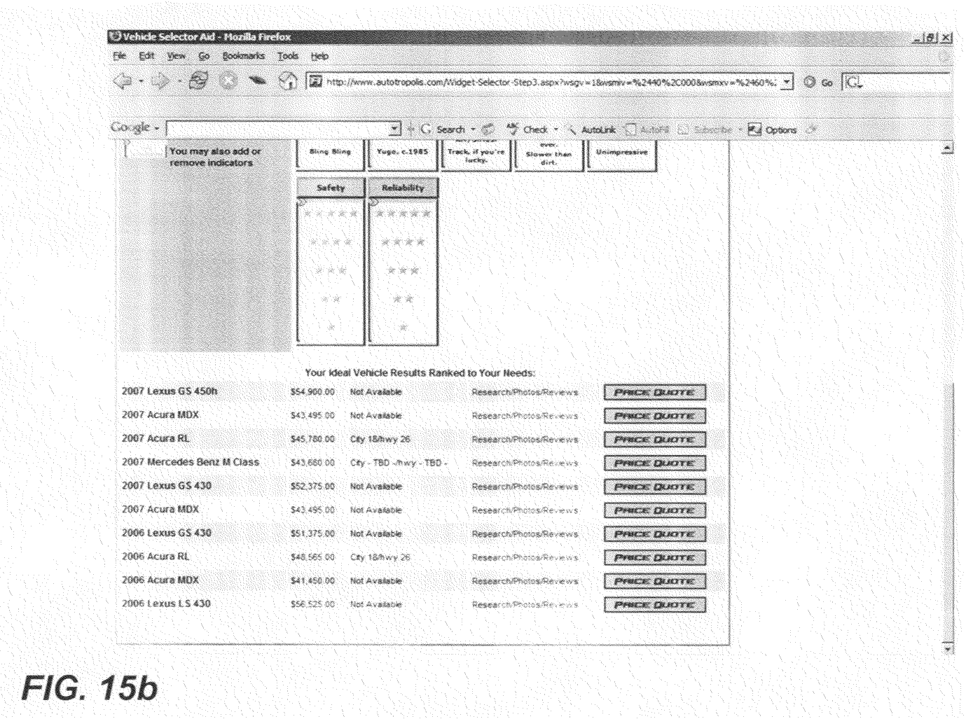

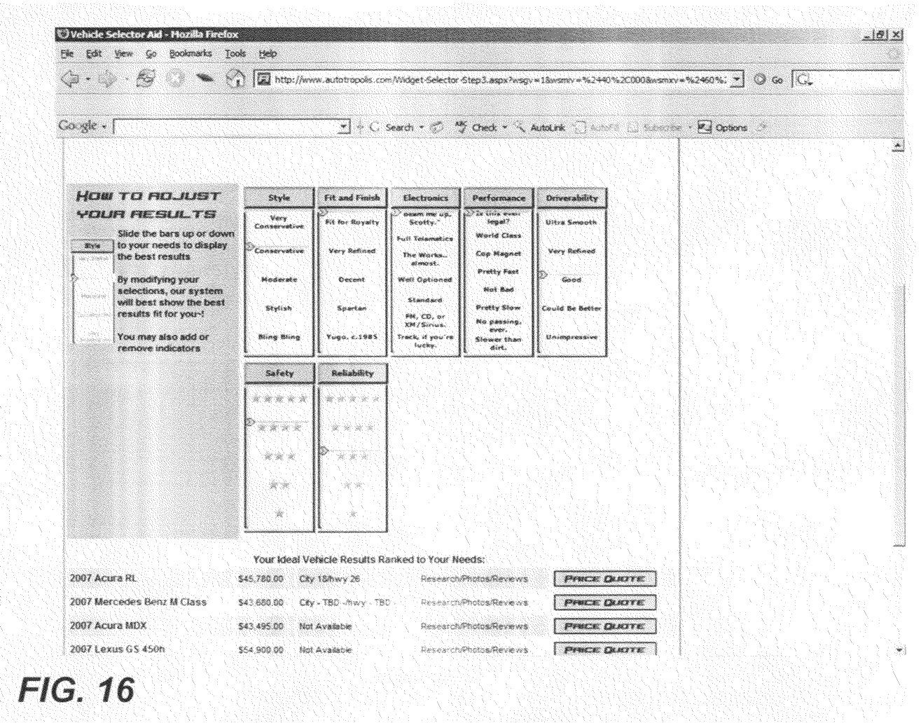

As illustrated in screen shots of FIGS. 15a and 15b, the newly-selected purchase factors 302 (with associated adjustment sub-ranges 308) may be added to the search criteria. Consumer 104 may further adjust target values. In FIG. 16, consumer 104 has selected a “four star” rating for the safety indicator and a “three-star” rating for the reliability indicator. Based on the new search criteria, a revised search of vehicle database 110 may be performed and the vehicle results updated. Consumer 104 may view the revised search results or perform alternative searches based on lifestyle categories 402 and/or purchase factors 302.

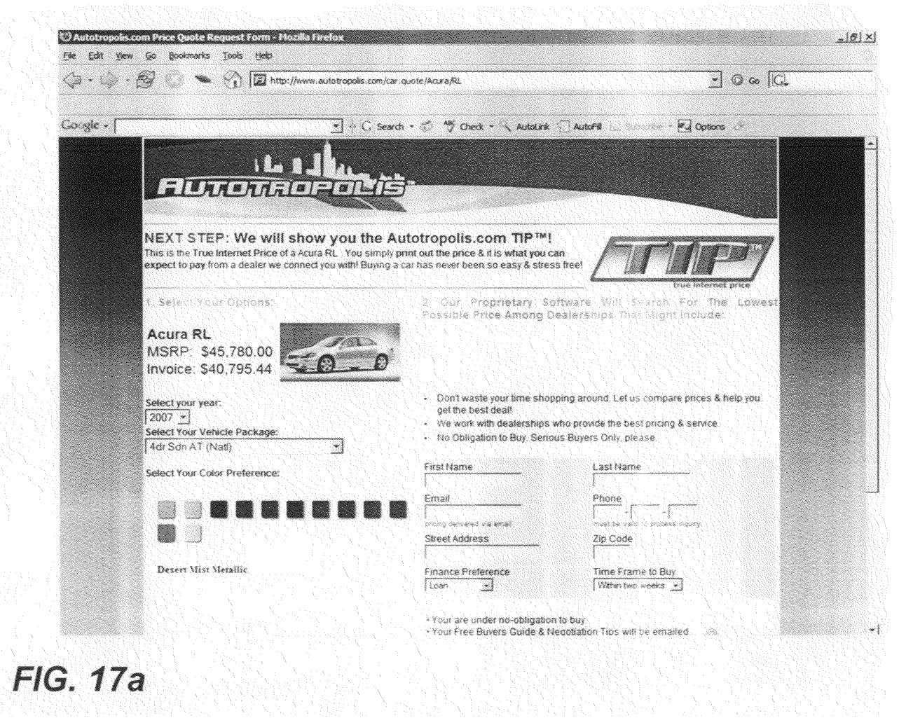

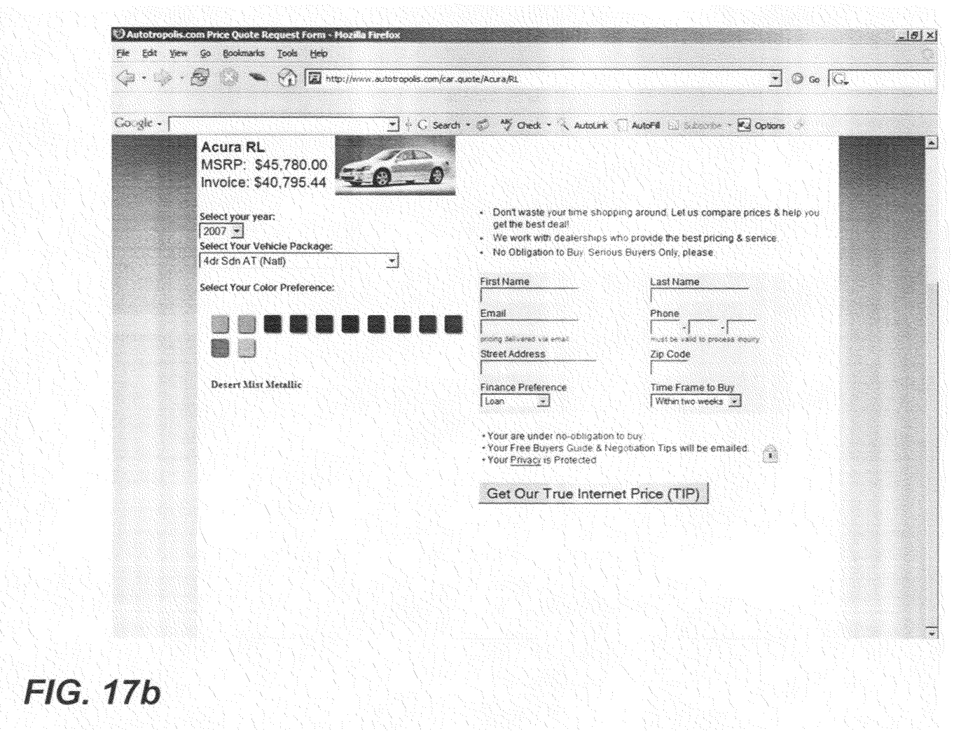

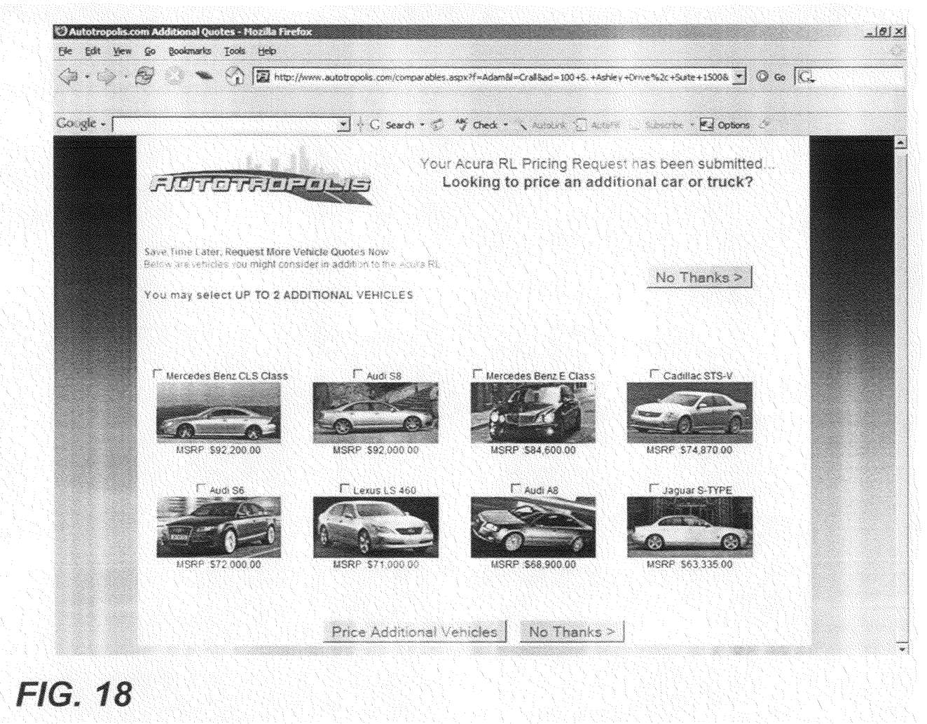

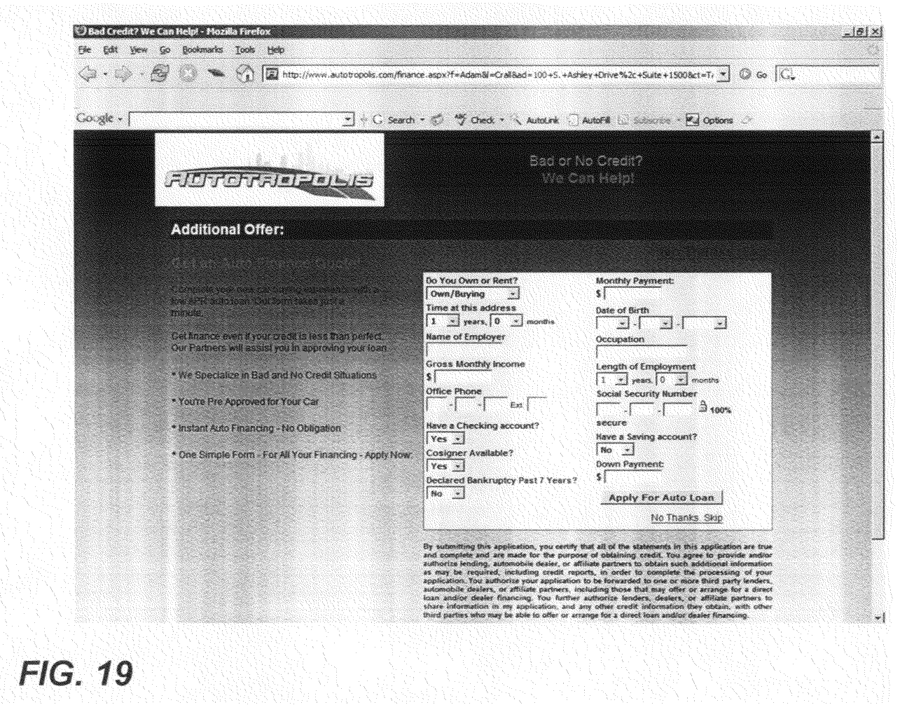

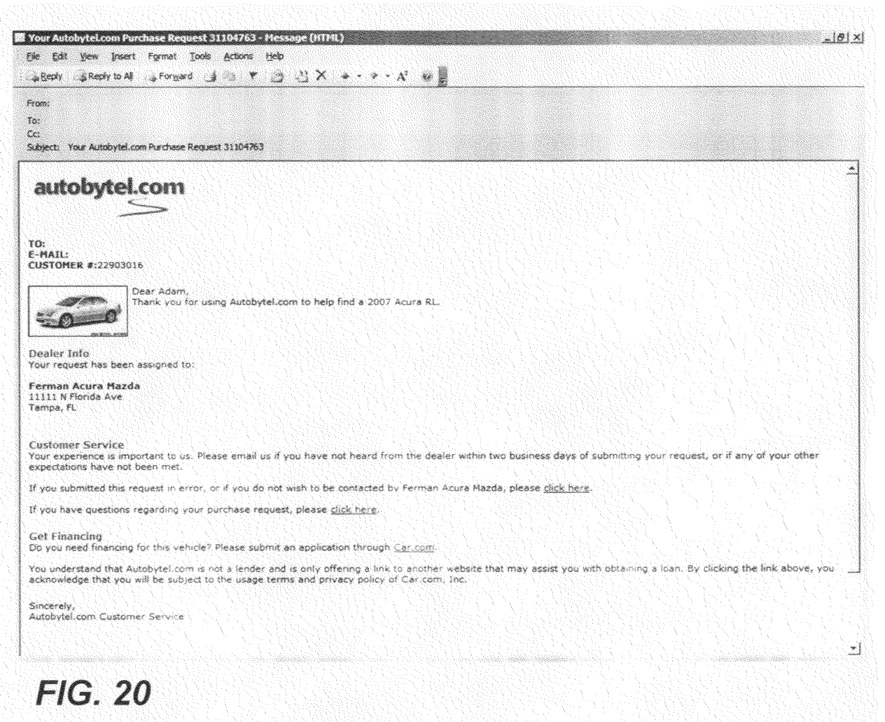

If consumer 104 locates a desirable vehicle, the “price quote” link may be engaged on the results web page. FIGS. 17a & 17b illustrate a web page for enabling consumer 104 to specify various vehicle options and request a price quote. In the illustrated embodiment, consumer 104 has selected an Acura RL and may further specify additional vehicle options, such as year, vehicle packages, and color. Consumer 104 may also provide contact information, financing preferences, and additional purchase characteristics. As illustrated in FIG. 18, consumer 18 may also specify additional vehicles for which to obtain price quotes, perhaps for comparative purposes. FIG. 19 illustrates a web page for enabling consumer 104 to apply for financing for the selected vehicle. After consumer 104 sends the price quote request, lifestyle-based vehicle selection system 102 may forward relevant information to dealer affiliate(s) 112. FIG. 20 illustrates an example of an introductory e-mail communication to consumer 104 from a dealer affiliate 112.

Although this disclosure describes the invention in terms of exemplary or disclosed embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A computer system for enabling consumers to research vehicles, the computer system comprising:
a vehicle database configured to store a plurality of vehicle profiles, each vehicle profile associated with a unique vehicle and comprising a plurality of indicators related to vehicle characteristics and corresponding uniquely-assigned weights; and
a lifestyle-based vehicle selection system for enabling a consumer to search the vehicle database, the lifestyle-based vehicle selection system comprising:
a user interface;
logic configured to prompt the consumer via the user interface to select at least one of a plurality of lifestyle categories, each lifestyle category associated with a portion of the plurality of indicators, the portion defining a set of primary indicators for a first search of the vehicle database;
logic configured to determine the set of primary indicators assigned to the selected lifestyle category; and
logic configured to initiate the first search of the vehicle database based on the set of primary indicators.

2. The computer system of claim 1, wherein the first search comprises ranking the vehicle profiles according to the uniquely-assigned weights corresponding to the primary indicators.

3. The computer system of claim 2, wherein the lifestyle-based vehicle selection system further comprises logic configured to present to the consumer, via the user interface, a list of matching vehicles resulting from the first search.

4. The computer system of claim 2, wherein the lifestyle-based vehicle selection system further comprises a search adjustment functionality for enabling the consumer to create a second search of the vehicle database by directly selecting one or more of the plurality of indicators rather than the lifestyle categories.

5. The computer system of claim 4, wherein the uniquely-assigned weights comprise a numerical value within a range, the range comprising a plurality of adjustment sub-ranges, and the search adjustment functionality comprises:
an indicator adjustment functionality for enabling the consumer to define search criteria for the second search, the indicator adjustment functionality comprising:
logic configured to enable the consumer to select one or more of the plurality of indicators for the second search;
logic configured to display the selected indicators for the second search with the corresponding adjustment sub-ranges; and
logic configured to enable the consumer to selectively adjust a target indicator value, for each selected indicator, from the adjustment sub-ranges.

6. The computer system of claim 5, wherein the indicator adjustment functionality implements a slider functionality for selectively adjusting the target indicator values.

7. A computer-implemented method for enabling consumers to search for vehicles-of-interest via a web site, the computer-implemented method comprising:
providing a database comprising:
a plurality of vehicle profiles, each vehicle profile associated with a unique vehicle and comprising (i) vehicle data related to the corresponding vehicle and (ii) a uniquely-assigned value for each of a plurality of purchase factors; and
a plurality of lifestyle categories, each lifestyle category associated with a unique sub-set of the plurality of purchase factors;
prompting a consumer to search the database of vehicles by selecting one of the plurality of lifestyle categories;
receiving a consumer selection of one of the plurality of lifestyle categories;
determining the unique sub-set of the plurality of purchase factors associated with the selected lifestyle category; and
determining a top-ranked list of the plurality of vehicle profiles according to the uniquely-assigned values for the unique sub-set of the plurality of purchase factors.

8. The computer-implemented method of claim 7, wherein the uniquely-assigned value comprises a numerical value within a range.

9. The computer-implemented method of claim 8, wherein the top-ranked list comprises a set of vehicle profiles having the highest sum of the numerical values for the unique sub-set of the plurality of purchase factors.

10. The computer-implemented method of claim 7, further comprising providing the top-ranked list and the unique sub-set of the plurality of purchase factors to the consumer.

11. The computer-implemented method of claim 10, further comprising enabling the consumer to re-search the database by directly specifying one or more of the plurality of purchase factors.

12. The computer-implemented method of claim 7, further comprising:
receiving from the consumer a vehicle selection from the top-ranked list; and
forwarding the consumer and the vehicle selection to an affiliate as a sales lead.

13. The computer-implemented method of claim 7, wherein the uniquely-assigned value comprises a numerical value within a range having a plurality of adjustment sub-ranges, and the computer-implemented method further comprising:
displaying the top-ranked list to the consumer;
displaying the unique sub-set of the plurality of purchase factors to the consumer with the corresponding plurality of adjustment sub-ranges; and
enabling the consumer to specify a revised search of the database by adding or removing one or more of the plurality of purchase factors to be searched and specifying one of the adjustment sub-ranges as a target range for the revised search.

14. The computer-implemented method of claim 13, further comprising updating the top-ranked list based on the revised search.

15. A computer system for enabling consumers to research vehicles, the computer system comprising:
a vehicle database configured to store a plurality of vehicle profiles, each vehicle profile associated with a unique vehicle and comprising a plurality of indicators related to vehicle characteristics and corresponding uniquely-assigned weights; and
a lifestyle-based vehicle selection system for enabling a consumer to search the vehicle database, the lifestyle-based vehicle selection system comprising:
a user interface;
a first search functionality for enabling the consumer to search the vehicle database based on a plurality of lifestyle categories, each lifestyle category associated with a portion of the plurality of indicators, the portion defining a set of primary indicators for a first search of the vehicle database, and the first search functionality comprising:
logic configured to prompt the consumer via the user interface to select at least one of the plurality of lifestyle categories;
logic configured to determine the set of primary indicators assigned to the selected lifestyle category; and
logic configured to initiate the first search of the vehicle database based on the set of primary indicators; and
a second search functionality for enabling the consumer to perform a second search of the vehicle database by directly selecting one or more of the plurality of indicators rather than the lifestyle categories.

16. The computer system of claim 15, wherein the lifestyle-based vehicle selection system is implemented via a web server.

17. The computer system of claim 15, wherein the plurality of lifestyle categories are selected from one or more of a family-car category, a second-car category, a value-buyer category, a comfortable category, a performance driver category, a style category, an off-road category, a towing-vehicle category, a safety-conscious category, a first-time-car-owner category, a college-driver category, a senior driver category, a frugal driver category, a long-distance-driving category, a working vehicle category, an executive/luxury category, a price-is-no-object category, and an environment-conscious category.

18. The computer system of claim 17, wherein the plurality of indicators are selected from one or more of a safety indicator, a reliability indicator, a mileage indicator, a style indicator, a price indicator, a cost-of-ownership indicator, a fit-and-finish indicator, a drive system indicator, a connectivity indicator, a performance indicator, a warranty indicator, a drivability-and-comfort indicator, a child-friendly indicator, a fuel selection indicator, and a towing indicator.

19. The computer system of claim 15, wherein the lifestyle-based vehicle selection system further comprises:
logic configured to receive a vehicle selection from the consumer; and
logic configured to forward the vehicle selection to an affiliate of the computer system as a sales lead.

20. The computer system of claim 19, wherein a sales-lead-fee is paid by the affiliate.
